(19) United States
(12) Patent Application Publication
(10) Pub. No.: US 2026/0117913 A1
(43) Pub. Date: Apr. 30, 2026

(54) VACUUM INSULATION MATERIAL AND METHOD OF MANUFACTURING THE SAME

(71) Applicant: HYUNDAI TRANSYS INC., Seosan-si (KR)

(72) Inventors: Jong Chan LEE, Hwaseong-si (KR); Hye Ju YOO, Hwaseong-si (KR); Hwa Jun LEE, Hwaseong-si (KR); Ho Sub LIM, Hwaseong-si (KR)

(21) Appl. No.: 19/340,990

(22) Filed: Sep. 26, 2025

(30) Foreign Application Priority Data
Oct. 4, 2024 (KR) 10-2024-0134602

(51) Int. Cl. F16L 59/065; B32B 37/18; B32B 38/00; B32B 38/06

(52) U.S. Cl. CPC F16L 59/065; B32B 37/18; B32B 38/0004; B32B 38/06; B32B 2305/024; B32B 2311/00; B32B 2323/00

(57) ABSTRACT

The present disclosure relates to a vacuum insulation material including a core material processed into a plurality of polygonal patterns and a cladding material configured to seal and vacuum-treat the core material and to receive the core material therein.

### CROSS-REFERENCE TO RELATED APPLICATION

This application claims, under 35 U.S.C. § 119(a), priority to Korean Patent Application No. 10-2024-0134602 filed on Oct. 4, 2024, the entire contents of which are incorporated herein by reference.

### BACKGROUND

### A Technical Field

The present disclosure relates to a vacuum insulation material and a method of manufacturing the same, and more particularly to a vacuum insulation material capable of being processed into a three-dimensional shape by bending and a method of manufacturing the same.

### (b) Background Art

Generally, insulation materials configured to limit heat transfer are used in buildings, pipes, ice boxes, and other structures where there is a temperature difference between the interior and the exterior.

Such insulation materials may be broadly categorized into general insulation materials and vacuum insulation materials.

General insulation materials have a thermal conductivity of approximately 30 mW/mK, whereas vacuum insulation materials have a thermal conductivity of approximately 3 mW/mK to 10 mW/mK. Consequently, vacuum insulation materials have approximately 3 to 10 times higher insulation performance than general insulation materials.

Despite high insulation properties, vacuum insulation materials have not been widely used due to high material costs and difficulty in manufacturing.

Recently, with many advances in manufacturing technology, countries such as Germany, the United Kingdom, Japan, the United States, Canada, South Korea, and China have been working to commercialize vacuum insulation materials, but high material and manufacturing process costs remain a significant burden.

Meanwhile, ceiling materials used in vehicles are typically molded into felt or board forms and attached to the ceiling of a vehicle to block noise from entering the interior from the outside and to improve the insulation performance of the vehicle.

In the case of such ceiling materials for vehicles, conventionally, there is a problem such as insufficient thermal insulation effects against heat entering from the outside of a vehicle compared to the sound absorption or soundproofing performance against noise entering from the outside of the vehicle, and there is another problem such as damage due to weight or sagging due to warping caused by insufficient product rigidity.

The above information disclosed in this Background period is provided only for enhancement of understanding of the background of the present disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art.

It is an aspect of the present disclosure to provide a vacuum insulation material configured such that a plate-shaped core material is processed so as to have a polygonal pattern, and the core material is sealed and vacuum-treated using a thin cladding material to form a vacuum insulation material having the patterned core material applied thereto, thereby enabling the processing of the vacuum insulation material into a three-dimensional shape by bending, and a method of manufacturing the same.

The aspects of the present disclosure are not limited to that described above. The aspects of the present disclosure will be clearly understood from the following description of embodiments and could be implemented by means defined in the claims and a combination thereof.

A vacuum insulation material according to an embodiment of the present disclosure includes a core material processed into a plurality of polygonal patterns and a cladding material configured to seal and vacuum-treat the core material and to receive the core material therein.

Bending areas are formed between neighboring polygonal patterns by stamping, and the cladding material is configured such that, as the cladding material is introduced into the bending areas, a first cladding material located above and a second cladding material located below come into contact with each other in the bending areas.

Bending portions are formed above boundary areas surrounding areas where the polygonal patterns are to be formed, and the cladding material may be configured such that, as a first cladding material located above is introduced into the bending portions, the core material and the first cladding material come into contact with each other in the bending portions.

Bending portions are formed by stamping boundary areas surrounding areas where the patterns are to be formed, a first core material and a second core material may be stacked to sandwich the core material, and the cladding material may be configured such that a first cladding material located above the first core material and a second cladding material located below the second core material are introduced into the bending portions such that the first core material and the second core material come into contact with each other in the bending portions.

Each of the first core material and the second core material may have a size and a shape corresponding to the size and the shape of the core material, and may be stacked to sandwich the core material in the state in which the polygonal patterns are not formed.

The cladding material may be made of polyolefin onto which one selected from the group consisting of aluminum, gold, silver, copper, nickel, cobalt, chromium, and tin is deposited.

A method of manufacturing a vacuum insulation material according to another embodiment of the present disclosure includes a pattern processing step of forming a plurality of polygonal patterns on a core material and a receiving step of sealing and vacuum-treating the core material using a cladding material and receiving the core material in the cladding material.

In the pattern processing step, a core material scrap generated by blanking the core material may be removed such that the core material is provided with a bending portions formed by stamping boundary areas surrounding areas where the polygonal patterns are to be formed.

In the receiving step, a first cladding material located above the core material and a second cladding material located below the core material may be introduced into the bending portions and come into contact with each other in the bending portions as the core material is sealed and vacuum-treated.

In the pattern processing step, a bending portions may be formed above boundary areas surrounding areas where the polygonal patterns are to be formed by stamping the core material.

In the receiving step, a first cladding material located above the core material may be introduced into the bending portions and come into contact with the core material in the bending portions as the core material is sealed and vacuum-treated.

In the pattern processing step, a core material scrap generated by blanking the core material may be removed such that the core material is provided with a bending portions formed by stamping boundary areas surrounding areas where the polygonal patterns are to be formed and a first core material and a second core material are stacked to sandwich the core material.

In the receiving step, a first cladding material located above the first core material and a second cladding material located below the second core material may be introduced into the bending portions such that the first core material and the second core material come into contact with each other in the bending portions as the core material is sealed and vacuum-treated.

Other aspects and preferred embodiments of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view showing a first embodiment of a vacuum insulation material according to an embodiment of the present disclosure;

FIG. 2 is a view showing different patterns of the vacuum insulation material according to the embodiment of present disclosure;

FIG. 3 is a view showing a first embodiment of a method of manufacturing a vacuum insulation material according to an embodiment of the present disclosure in sequence;

FIG. 4 is a view showing the structure of the first embodiment of the vacuum insulation material according to the embodiment of the present disclosure;

FIG. 5 is a view showing a second embodiment of the method of manufacturing the vacuum insulation material according to the embodiment of the present disclosure in sequence;

FIG. 6 is a view showing the structure of a second embodiment of the vacuum insulation material according to the embodiment of the present disclosure;

FIG. 7 is a view showing a third embodiment of the method of manufacturing the vacuum insulation material according to the embodiment of the present disclosure in sequence; and

FIG. 8 is a view showing the structure of a third embodiment of the vacuum insulation material according to the embodiment of the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, positions, and shapes, will be determined in part by the particular intended application and use environment.

In the figures, reference numbers refer to the same or equivalent parts of the present disclosure throughout the several figures of the drawing.

### DETAILED DESCRIPTION

Hereinafter, preferred embodiments of the present disclosure will be described in detail with reference to the accompanying drawings.

Advantages and features of the present disclosure and methods for achieving the same will be clearly understood with reference to the following detailed description of embodiments in conjunction with the accompanying drawings.

However, the present disclosure is not limited to the embodiments disclosed herein and may be implemented in various different forms. The embodiments are merely given to make the disclosure of the present disclosure perfect and to perfectly instruct the scope of the disclosure to those skilled in the art, and the present disclosure should be defined by the scope of claims.

Furthermore, in describing the present disclosure, a detailed description of the related prior art will be omitted when the same may obscure the subject matter of the present disclosure.

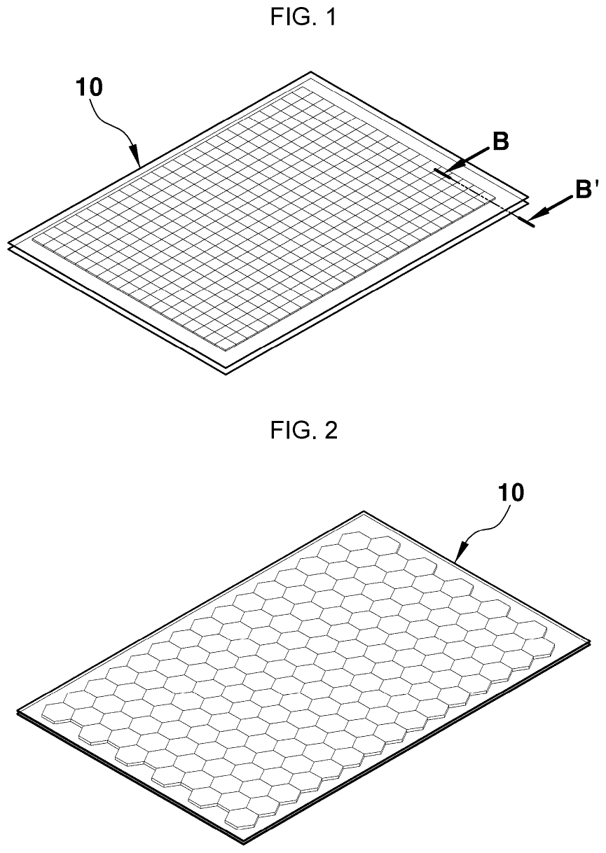

FIG. 1 is a view showing a first embodiment of a vacuum insulation material according to an embodiment of the present disclosure, and FIG. 2 is a view showing different patterns of the vacuum insulation material according to the embodiment of present disclosure.

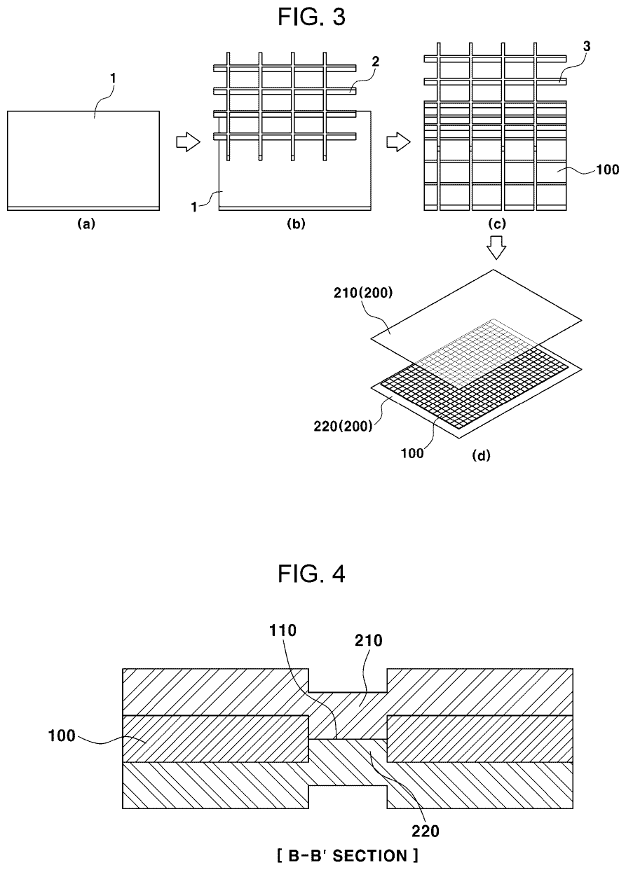

FIG. 3 is a view showing a first embodiment of a method of manufacturing a vacuum insulation material according to an embodiment of the present disclosure in sequence, and FIG. 4 is a view showing the structure of the first embodiment of the vacuum insulation material according to the embodiment of the present disclosure;

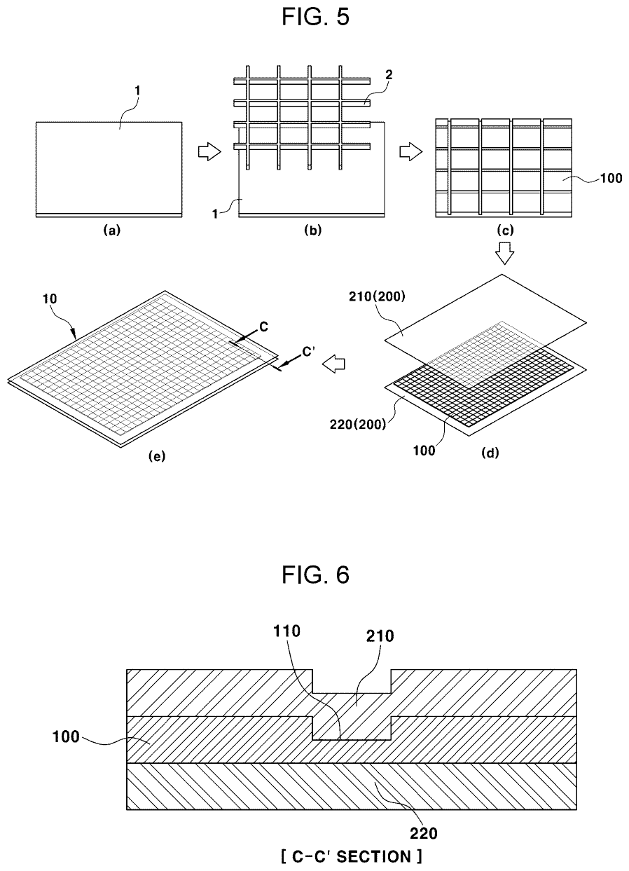

FIG. 5 is a view showing a second embodiment of the method of manufacturing the vacuum insulation material according to the embodiment of the present disclosure in sequence, and FIG. 6 is a view showing the structure of a second embodiment of the vacuum insulation material according to the embodiment of the present disclosure.

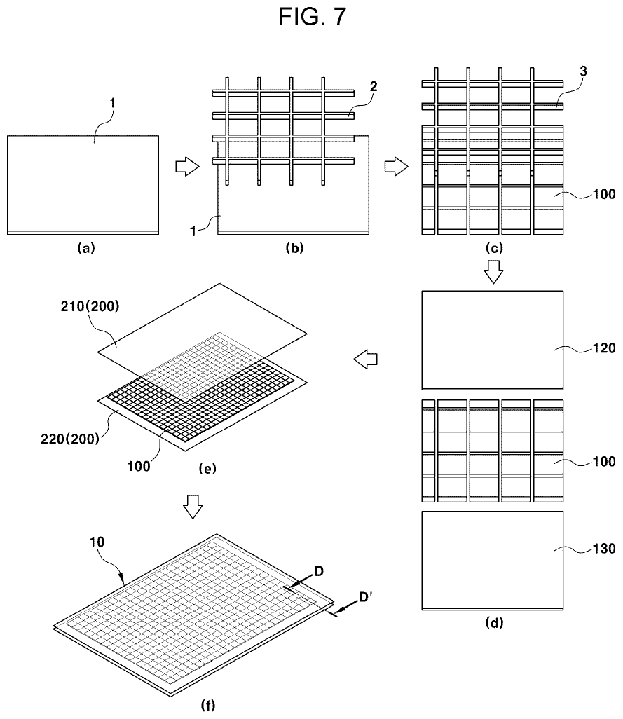

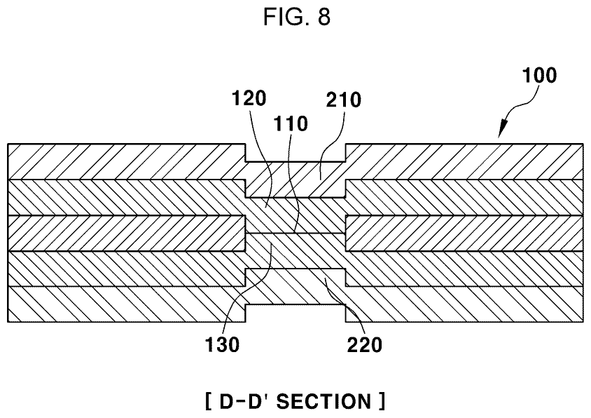

FIG. 7 is a view showing a third embodiment of the method of manufacturing the vacuum insulation material according to the embodiment of the present disclosure in sequence, and FIG. 8 is a view showing the structure of a third embodiment of the vacuum insulation material according to the embodiment of the present disclosure.

As shown in FIG. 1, a vacuum insulation material is a high-efficiency insulation material with low thermal conductivity, and may be produced into various plate shapes by adjusting the size and thickness of a core material provided therein.

That is, a general vacuum insulating material may be manufactured by wrapping the top and the bottom of a porous core material cut into a plate shape with a thin sheet-shaped cladding material to seal the porous core material and performing vacuum treatment to form an internal vacuum space.

However, the main component of the core material is glass fiber, and the main component of the cladding material is aluminum, both of which are prone to deformation and damage due to external force, whereby it is difficult to process the vacuum insulation material in the plate shape into a three-dimensional form by bending.

To this end, in the present embodiment, as shown in FIGS. 1 and 2, a pattern processed into a plurality of polygonal shapes, such as a quadrangle or a hexagon, is formed on a core material 100 received in a vacuum insulation material 10, thereby enabling three-dimensional shaping of the vacuum insulation material 10.

The core material 100 constituting the vacuum insulation material 10 is formed so as to have polygonal patterns, and a cladding material 200 is formed to seal and vacuum-treat the core material 100 and to receive the same therein.

In other words, the vacuum insulation material 10 may include a core material 100 and a cladding material 200 configured to wrap and receive the core material 100 while having a gas barrier property. More preferably, the vacuum pressure in the core material 100 may be 10⁻⁵ to 10⁻² Torr.

The core material 100 is preferably prepared by mixing a metal or glass with an epoxy resin as a binder, and the binder is not particularly limited as long as the binder can be used as a metal or glass binder.

It is desirable that an adsorbent (not shown) configured to absorb gas components be provided in the core material 100. The adsorbent is not particularly limited as long as it is possible to adsorb gas in the core material 100. More specifically, the adsorbent may be made of any one selected from the group consisting of activated carbon, silica gel, aluminum oxide, molecular sieves, zeolite, calcium oxide, barium oxide, calcium chloride, magnesium oxide, magnesium chloride, iron, zinc, a barium-lithium alloy, and a zirconium-based alloy.

The cladding material 200 wraps and receives the core material 100 therein and is formed to have a gas barrier property. After the core material 100 is received in the cladding material 200, the cladding material 200 is formed such that air is blocked by hermetically bonding edges of a first cladding material 210 and a second cladding material 220 that come into contact with each other using a method such as heat fusion.

The cladding material 200 may be made of polyolefin coated with a metal selected from the group consisting of aluminum, gold, silver, copper, nickel, cobalt, chromium, and tin. When the cladding material 200 made of polyolefin with a metal deposited thereon is used, the gas barrier property of the cladding material 200 may be further improved, thereby enabling the vacuum state of the vacuum insulation material 10 to be maintained for a long time.

### First Embodiment

The interior of a vacuum insulation material 10 is sealed and vacuum-treated through a cladding material 200 in the state in which a polygonal pattern, such as a quadrangular pattern, is formed on a core material 100 through sequential processes, thereby enabling the three-dimensional shaping of the vacuum insulation material 10.

As shown in FIGS. 3(a) and 3(b), a plate-shaped core material 1 is prepared, and the plate-shaped core material 1 is blanked using a press die 2 with a pattern formed thereon.

As shown in FIG. 3(c), a core material scrap 3 generated during the blanking process is removed and separated to form a core material 100 with a pattern formed therethrough, and as shown in FIG. 3(d), the core material 100 is sealed and vacuum-treated using a first cladding material 210 and a second cladding material 220, thereby forming a vacuum insulation material 10 with a pattern formed on the core material 100.

As a result, in this embodiment, the core material 100 is blanked to form a pattern, and the core material 100 provided with bending areas 110 formed by stamping a boundary area of the pattern is sealed and vacuum-treated through the cladding material 200. At this time, the first cladding material 210 and the second cladding material 220 located at the top and the bottom of the core material 100 are brought into contact with each other in the bending areas 110, thereby forming a vacuum insulation material 10 having a sectional structure as shown in FIG. 4.

Accordingly, in this embodiment, the bending areas 110 stamped to form a pattern on the core material 100, and when the core material 100 is sealed and vacuum-treated using the cladding material 200, the first cladding material 210 and the second cladding material 220 are introduced into the bending areas 110 of the core material 100 and come into contact with each other, thereby forming the vacuum insulation material 10. This may reduce the thickness of the bending areas 110, thereby improving the processability for three-dimensional shaping of the vacuum insulation material 10 based on the pattern.

### Second Embodiment

The interior of a vacuum insulation material 10 is sealed and vacuum-treated through a cladding material 200 in the state in which a polygonal pattern, such as a quadrangular pattern, is formed on a core material 100 through sequential processes, thereby enabling the three-dimensional shaping of the vacuum insulation material 10.

As shown in FIGS. 5(a) and 5(b), a plate-shaped core material 1 is prepared, and the top of the plate-shaped core material 1 is stamped using a press die 2 with a pattern formed thereon.

As shown in FIG. 5(c), the core material 100 with the pattern formed by stamping is separated from the press die 2, and as shown in FIG. 5(d), the core material 100 is sealed and vacuum-treated with a first cladding material 210 and a second cladding material 220 to form a vacuum insulation material 10 with a pattern formed on the core material 100, as shown in FIG. 5(e).

As a result, in this embodiment, the core material 100 is stamped to form a pattern, and the core material 100 provided with bending portions 110 formed while stamping a boundary area of the pattern is sealed and vacuum-treated through the cladding material 200. At this time, the first cladding material 210 located at the top of the core material 100 is introduced into the bending portions 110 and comes into contact with the core material 100 in the bending portions 110, thereby forming a vacuum insulation material 10 having a sectional structure as shown in FIG. 6.

Accordingly, in this embodiment, the bending portions 110 are stamped to form a pattern on the core material 100, and when the core material 100 is sealed and vacuum-treated using the cladding material 200, the first cladding material 210 is introduced into the bending portions 110 of the core material 100 and the bending portions 110 and the first cladding material 210 come into contact with each other, thereby forming the vacuum insulation material 10. This may reduce the thickness of the bending portions 110, thereby improving the processability for three-dimensional shaping of the vacuum insulation material 10 based on the pattern.

Furthermore, in this embodiment, since a pattern is formed on the core material 100 through the stamping process, the core material 100 may also be applied to the bending portions 110 during sealing and vacuum treatment, thereby providing excellent vacuum insulation performance, compared to the first embodiment.

### Third Embodiment

The interior of a vacuum insulation material 10 is sealed and vacuum-treated through a cladding material 200 in the state in which a polygonal pattern, such as a quadrangular pattern, is formed on a core material 100 through sequential processes, thereby enabling the three-dimensional shaping of the vacuum insulation material 10. As shown in FIGS. 7(a) and 7(b), a plate-shaped core material 1 is prepared, and the plate-shaped core material 1 is blanked using a press die 2 with a pattern formed thereon.

As shown in FIG. 7(c), a core material scrap 3 generated during the blanking process is removed and separated to form a core material 100 with a pattern formed therethrough, and as shown in FIG. 7(d), a first core material 120 and a second core material 130 in a plate shape with no pattern formed thereon are stacked to sandwich the core material 100.

Subsequently, as shown in FIG. 7(e), the core material 100 having the first core material 120 and the second core material 130 stacked thereon is sealed and vacuum-treated using a first cladding material 210 and a second cladding material 220, thereby forming a vacuum insulation material 10 having a core material stacking structure in which the pattern is formed on the core material 100, as shown in FIG. 7(f).

As a result, in this embodiment, the core material 100 is blanked to form a pattern, the first core material 120 and the second core material 130 are stacked on the patterned core material 100, and the core material 100 provided with bending portions 110 formed by stamping a boundary area of the pattern is sealed and vacuum-treated through the cladding material 200. At this time, the first cladding material 210 located at the top of the first core material 120 and the second cladding material 220 located at the bottom of the second core material 130 are introduced into the bending portions 110, thereby forming a vacuum insulation material 10 having a sectional structure as shown in FIG. 8.

Accordingly, in this embodiment, the bending portions 110 are stamped to form a pattern on the core material 100, and when the core material 100 is sealed and vacuum-treated using the cladding material 200 in the state in which the plate-shaped first core material 120 and the plate-shaped second core material 130 are stacked on the patterned core material 100, the first cladding material 210 and the second cladding material 220 are introduced into the bending portions 110 of the core material 100 and come into contact with each other in the bending portions 110, thereby forming the vacuum insulation material 10. This may reduce the thickness of the bending portions 110, thereby improving the processability for three-dimensional shaping of the vacuum insulation material 10 based on the pattern.

Furthermore, in this embodiment, since a pattern is formed on the core material 100 through the blanking process and the first core material 120 and the second core material 130 are stacked on the core material 100, a multilayer structure of the first core material 120 and the second core material 130 may also be applied to the bending portions 110 during sealing and vacuum treatment, thereby providing excellent vacuum insulation performance for the bending portions 110, compared to the second embodiment.

As is apparent from the foregoing, in the present disclosure, a plate-shaped core material is processed so as to have a polygonal pattern, and the core material is sealed and vacuum-treated using a thin cladding material to form a vacuum insulation material having the patterned core material applied thereto, whereby the present apparatus and method have the effect of enabling the processing of the vacuum insulation material into a three-dimensional shape by bending.

In addition, in the present disclosure, the plate-shaped core material is processed so as to have a polygonal pattern, additional plate-shaped core materials are stacked on the top and the bottom of the patterned core material, and sealing and vacuum treatment are performed using a thin cladding material to form a vacuum insulation material having the patterned core material applied thereto, whereby the present apparatus and method have the effect of enabling the processing of the vacuum insulation material into a three-dimensional shape by bending while the vacuum insulation material provides excellent insulation performance.

Although the present disclosure has been described with reference to the embodiment(s) shown in the drawings, which are merely illustrative, those skilled in the art will understand that various modifications are possible therefrom and all or some of the embodiment(s) may be selectively combined. Therefore, the real technical protection scope of the present disclosure is defined by the technical idea of the appended claims.

What is claimed is:

1. A vacuum insulation material comprising:
a core material processed into a plurality of polygonal patterns; and
a cladding material configured to seal and vacuum-treat the core material and to receive the core material therein.

2. The vacuum insulation material according to claim 1, wherein:
bending areas are formed between neighboring polygonal patterns by stamping, and
the cladding material is configured such that, as the cladding material is introduced into the bending areas, a first cladding material located above and a second cladding material located below come into contact with each other in the bending areas.

3. The vacuum insulation material according to claim 1, wherein:
bending portions are formed above boundary areas surrounding areas where the polygonal patterns are to be formed, and
the cladding material is configured such that, as a first cladding material located above is introduced into the bending portions, the core material and the first cladding material come into contact with each other in the bending portions.

4. The vacuum insulation material according to claim 1, wherein
bending portions are formed by stamping boundary areas surrounding areas where the polygonal patterns are to be formed,
a first core material and a second core material are stacked to sandwich the core material, and
the cladding material is configured such that a first cladding material located above the first core material and a second cladding material located below the second core material are introduced into the bending portions such that the first core material and the second core material come into contact with each other in the bending portions.

5. The vacuum insulation material according to claim 4, wherein each of the first core material and the second core material has a size and a shape corresponding to a size and a shape of the core material, and is stacked to sandwich the core material in a state in which the polygonal patterns are not formed.

6. The vacuum insulation material according to claim 1, wherein the cladding material is made of polyolefin onto which one selected from a group consisting of aluminum, gold, silver, copper, nickel, cobalt, chromium, and tin is deposited.

7. A method of manufacturing a vacuum insulation material, the method comprising:
a pattern processing step of forming a plurality of polygonal patterns on a core material; and
a receiving step of sealing and vacuum-treating the core material using a cladding material and receiving the core material in the cladding material.

8. The method according to claim 7, wherein, in the pattern processing step, a core material scrap generated by blanking the core material is removed such that the core material is provided with bending portions formed by stamping boundary areas surrounding areas where the polygonal patterns are to be formed.

9. The method according to claim 8, wherein, in the receiving step, a first cladding material located above the core material and a second cladding material located below the core material are introduced into the bending portions and come into contact with each other in the bending portions as the core material is sealed and vacuum-treated.

10. The method according to claim 7, wherein, in the pattern processing step, a bending portions is formed above boundary areas surrounding areas where the polygonal patterns are to be formed by stamping the core material.

11. The method according to claim 10, wherein, in the receiving step, a first cladding material located above the core material is introduced into the bending portions and comes into contact with the core material in the bending portions as the core material is sealed and vacuum-treated.

12. The method according to claim 7, wherein, in the pattern processing step, a core material scrap generated by blanking the core material is removed such that the core material is provided with a bending portions formed by stamping boundary areas surrounding areas where the polygonal patterns are to be formed and a first core material and a second core material are stacked to sandwich the core material.

13. The method according to claim 12, wherein, in the receiving step, a first cladding material located above the first core material and a second cladding material located below the second core material are introduced into the bending portions such that the first core material and the second core material come into contact with each other in the bending portions as the core material is sealed and vacuum-treated.
